(19) United States
(12) Patent Application Publication
(10) Pub. No.: US 2021/0031399 A1
(43) Pub. Date: Feb. 4, 2021

(54) Planer Jig

(71) Applicant: Howard Chris Murray, Whittier, CA (US)

(72) Inventor: Howard Chris Murray, Whittier, CA (US)

(21) Appl. No.: 16/525,397

(22) Filed: Jul. 29, 2019

(51) Int. Cl. B27C 1/14; B27C 1/04

(52) U.S. Cl. CPC B27C 1/14; B27C 1/04

(57) ABSTRACT

A tool comprising of adjustable parts used in conjunction with a thickness planer to surface a face of a solid wood board flat.

### FIELD

The present invention relates to a planer sled. More particularly, the present invention pertains to a planer sled comprising of a sidewall extending upward from a base, wherein the sidewalls extending upward from a base, are arranged perpendicularly to each other. The first and second sidewalls are configured to abut a wooden board, wherein a plurality of cylindrical members dispose within corresponding apertures within the base are further configured to abut the wooden board, such that the wooden board is frictionally secured within the cylindrical members and the sidewalls and may be inserted into a typical thickness planer to achieve a desired dimension.

### BACKGROUND

Woodworking often requires specialized tools prior to performing a desired task, such as installing a doorframe or hardwood flooring. A wooden board having rough edges and uneven surfaces, can diminish the quality of a product and be unsightly, such as hardwood flooring, that is created with a wooden board. Woodworkers often use a typical jointer to smoothen a wooden board, while employing a typical thickness planer to create a wooden board with a uniform and smooth thickness on all its faces.

Wooden boards often exhibit grains of dissimilar grain sizes, as well as cupping, wherein a central portion of the wooden board fails to be collinear with a distal end of the wooden board, such that a surface of the wooden board is uneven. Woodworkers may typically be required to shift between smoothing a rough uneven board face using a traditional jointer while attempting to dimension the wooden board using a thickness planer. Unfortunately, shifting between the jointer and thickness planer can be time consuming and inconvenient. Often, woodworkers may place the wooden board on a sled to use the thickness planer for both dimensioning and smoothing the wooden board to eliminate the need for a jointer. However, such sleds are typically unable to provide a support surface to a wooden board of a desired width and length, and are cumbersome and difficult to use.

The present invention differs from these commonly used sleds in that the present invention provides a sled having a plurality of cylindrical members that are positioned on predefined and even intervals to support a wooden board when inserting the wooden board into a thickness planer. In this way, a user may create a desired uniform thickness of a wooden board with a desired width and length, such that the user may proceed with a suitable woodworking operation, such as to install hardwood flooring, or the like of dimensional lumber needed.

### SUMMARY OF THE INVENTION

The present invention relates to a planer sled. More particularly, the present invention pertains to a planer sled comprising a base having a first sidewall extending upwardly from a longitudinal side thereof, and a second sidewall adjacent the first sidewall. The first sidewall and the second sidewall are positioned such that they are orthogonal to each other, so as to provide a substantial surface area of fractional contact with a wooden board. The first and second sidewalls are configured to abut the wooden board, wherein a plurality of cylindrical members dispose within corresponding apertures within the base are further configured to abut the wooden board, such that the wooden board is frictionally secured within the cylindrical members and sidewalls and may be inserted into a typical thickness planer to achieve a desired uniform thickness, width, and length thereof.

### BRIEF DESCRIPTION OF THE DRAWINGS

Although the characteristics features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the planer sled 200.

FIG. 2 shows a top plan view of an embodiment of the planer sled. The planer sled 200, comprises of a flat surface 201, with sides walls 202, and a back wall 203, with 204 threaded holes for insertion of 208 threaded dowels with a 208A slotted end, and 204 holes for stop dowels 207 and wedges 206 along with an abrasive surface 207.

FIG. 3 shows a bottom plan view of an embodiment of the planer sled. Showing 203A the slotted end of the adjustable screws.

FIG. 4 shows a side elevation view of an embodiment of the planer sled. The back 203, and side wall 202, and the 208 adjustable screws along with the 207 dowels and the 205 wedges.

FIG. 5 shows an additional side elevation view of an embodiment of the planer sled.

FIG. 6 shows a further side elevation view of an embodiment of the planer sled, front and back views.

FIG. 7 shows a close up view of a contact member of an embodiment of the planer sled.

FIG. 8 shows an additional perspective view of an embodiment of the planer sled.

### DETAILED DESCRIPTION OF THE INVENTION

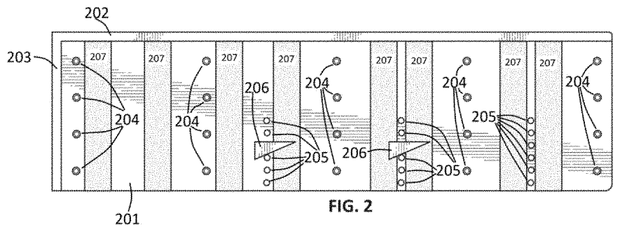

Referring to FIG. 2, there is shown a top plan view of an embodiment of the planer sled. The planer sled comprises a base having a plurality of sidewalls extending upwardly therefrom, wherein the sidewalls are oriented perpendicularly to each other. The sidewalls comprise of a linear configuration, such that the sidewalls may abut a wooden board and provide a stable and uniformly linear surface with which to frictionally contact the wooden board. In the shown embodiment a plurality of cylindrical members are configured to support a plurality of stop members in a colinear configuration. The stop members comprise a triangular shape, wherein a first side of the stop member is configured to abut a side of the cylindrical member, while a second side of a stop member is configured to be parallel with a corresponding second side of a second stop member that is collinear with a second side of the first stop, such that the second sides of the stop members may further abut the wooden board and secure the wooden board within.

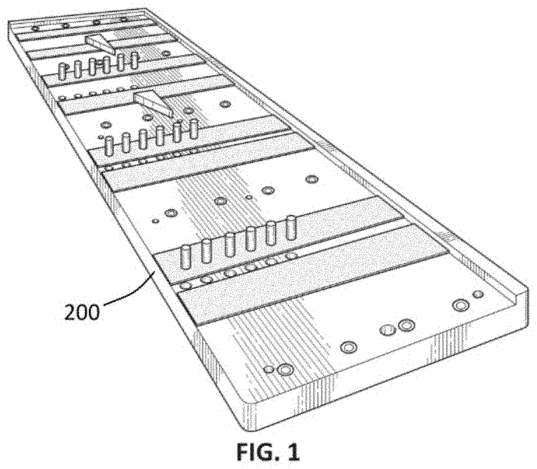

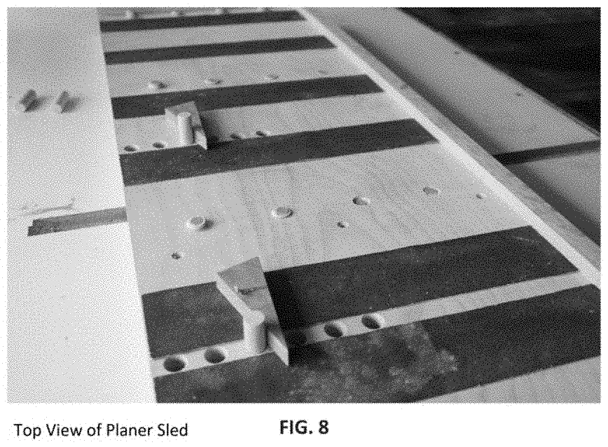

Referring to FIGS. 1 and 8, there are shown perspective views of an embodiment of the planer sled. In the shown embodiment, the cylindrical members are insertable through corresponding apertures disposed on an upper end of the base. In the shown embodiment, the apertures are arranged along an even interval, such that the cylindrical members are aligned in an even interval for supporting the wooden board thereon. Further, in the shown embodiment, the upper end of the base comprises a plurality of strips extending from the sidewall to an opposing side of the base that are configured to provide a frictional surface to support the wooden board received thereon. The strips may be composed of sandpaper or any other suitable material.

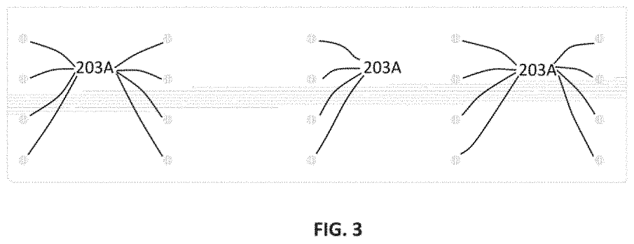

Referring now to FIG. 3, there is shown a bottom plan view of an embodiment of the planer sled. In the shown embodiment, a plurality of support members are disposed within corresponding apertures on a lower end of the base. The support members each comprise of a notch on a lower end thereof that is sized to receive a traditional flathead screwdriver, such that the user may rotatably secure the support members so as to selectively adjust an elevation of the support members, such that the base is raised to a desired elevation, and upon loosening of the support members within the apertures, the base may be selectively raised to a desired elevation.

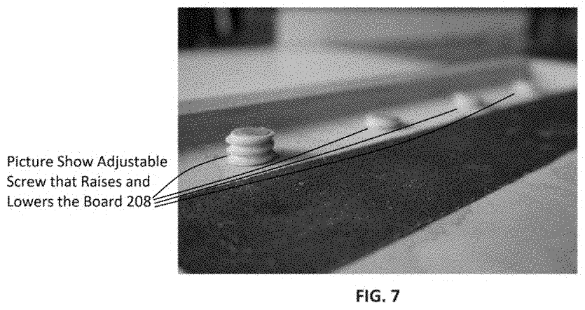

Referring to FIG. 7. There is shown a close-up view of a contact member of an embodiment of the planer sled. The contact member is configured to provide an additional frictional surface for supporting the wooden board, such that the wooden board does not slip on the sled while being inserted into the thickness planer. In the shown embodiment, the contact member comprises a circular shape, where multiple contact members may be arranged in a stacked configuration, wherein the user may selectively adjust an elevation of the contact members to effectively contact a wooden board with uneven thickness or cupping. The contact members may be secured to each other via a glue adhesive or other suitable fasteners. In addition, and upper surface of each contact member comprises a texturized surface for frictional engagement when supporting the wooden board. In the shown embodiment, the contact member comprises an upper end having a tapering configuration, thereby providing a contact surface that exerts a higher pressure to the wooden board.

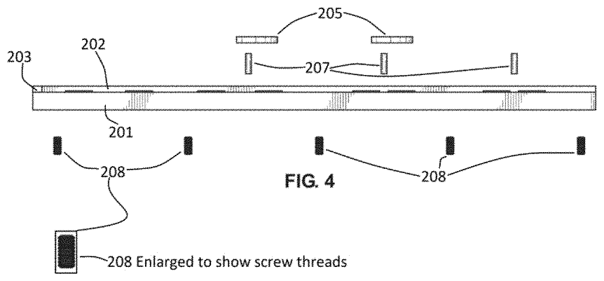

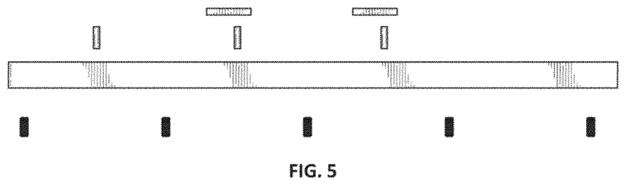

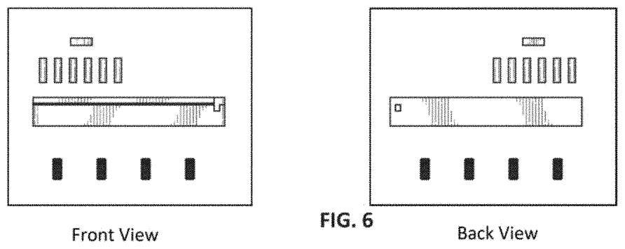

Referring now to FIG. 4-6, there are shown side elevation views of an embodiment of the planer sled. In the shown embodiment, the support members and the cylindrical members are arranged in a staggered configuration, whereby the apertures corresponding to the support members may not extend into the apertures corresponding to the cylindrical members. The cylindrical members may be spaced along any desired interval, such as in a clustered configuration on a rear side of the base.

In operation, the user may selectively adjust the support members to raise the base to a desired elevation. The user may then selectively adjust the contact members to a desired elevation, such that they contact members may adequately contact a wooden board exhibiting an uneven thickness or cupping. The user may then abut the wooden board flush against the sidewalls of the base, wherein the user may insert the cylindrical members to a desired aperture, such that the stop members may further abut the wooden board, such that a substantial perimeter of the wooden board is frictionally secured within the stop members and the sidewalls. In this way, the user may insert the wooden board into the thickness planer, thereby achieving a desired uniform thickness, width and length.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A device comprising of a flat surface and adjustable parts to surface wood flat using a thickness planer.

2. A devise that allows a board to be raised and lowered incrementally for the purpose of flattening a surface face by using its adjustable tooling.

3. A devise according to claim 1 that is used in conjunction with a thickness planer.

4. A device according to claim 2 that is used without the need for a jointer.

5. A device according to claim 1 that will flatten a boards face without the need of a jointer, through the use of a thickness planer.

6. A devise according to claim 1 that can be used to surface the second face of a board, example: to create a wedge-shaped board.

7. A device according to claim 1 that eliminates the need for a jointer.

8. A devise according to claim 1, that will flatten a boards face on either side regardless of the board's irregularities.

9. A device that can be produced in different lengths.

10. A device that can be produced in different widths.
